(19) United States
(12) Patent Application Publication
(10) Pub. No.: US 2009/0234723 A1
(43) Pub. Date: Sep. 17, 2009

(54) PUBLICLY GENERATED ADVERTISEMENT SYSTEM AND METHOD

(75) Inventor: Theresa K. Grevell, Walworth, NY (US)

Correspondence Address: George Likourezos, Esq.;Carter, DeLuca, Farrell & Schmidt, LLP, Suite 225, 445 Broad Hollow Rd., Melville, NY, 11747, US

(73) Assignee: Xerox Corporation

(21) Appl. No.: 12/045,996

(22) Filed: Mar. 11, 2008

(51) Int. Cl. G06Q 30/00

(52) U.S. Cl. 705/14

(57) ABSTRACT

An electronic advertisement system for displaying and exchanging advertisements includes an input interface operably coupled to a processing module. The input interface is configured to communicate at least one advertisement to the processing module. The processing module includes a processor configured to process the at least one advertisement communicated from the input interface and a memory operably coupled to the processor. The memory is configured to store the at least one processed advertisement. The system further includes at least one display device operably coupled to the processing module. The at least one display device is configured to receive the at least one processed advertisement from the processing module and display a representation of the at least one advertisement thereon. The system further includes an output interface operably coupled to the processing module. The output interface is configured to retrieve the at least one processed advertisement stored in the memory and output a representation of the at least one advertisement based on the at least one retrieved processed advertisement.

### BACKGROUND

1. Technical Field

The present disclosure relates to advertisement systems, and, in particular, to a system and method for displaying and exchanging an advertisement over an electronic advertisement system.

2. Description of Related Art

Bulletin board advertisements take on many forms, such as posters, business cards, fliers, etc. Typically, bulletin boards are utilized in public spaces (e.g., malls, libraries, university common areas, etc.) to facilitate the exchange of advertisements, information, public announcements, event announcements, help-wanted advertisements, lost item/pet posters, etc., between the posting party (the “advertiser”) and an interested party (the “consumer”). Consumers interested in a particular item posted on the bulletin board must have a pen and paper handy to write down information related to that item (e.g., contact information, item description, important dates, etc.) or, alternatively, must remove the item in which they are interested from the bulletin board to take with them.

Further, conventional bulletin boards often suffer from overcrowding of postings. Typically, bulletin boards are governed by the public for the public. That is, advertisers may post items on a bulletin board at no charge and for no enforceable time limit or expiration. As such, bulletin boards often become messy and overcrowded with duplicate items, items posted over other items, and items that have become obsolete. Further, conventional bulletin boards create no revenue for the owner of the space in which the bulletin board is located.

### SUMMARY

The present disclosure relates to electronic advertisement systems, and, in particular, to a system and method for displaying and exchanging publicly generated advertisements over an electronic advertisement system.

In an embodiment of the present disclosure, an electronic advertisement system for displaying and exchanging advertisements includes an input interface operably coupled to a processing module. The input interface is configured to communicate at least one advertisement to the processing module. The processing module includes a processor configured to process the at least one advertisement communicated from the input interface and a memory operably coupled to the processor. The memory is configured to store the at least one processed advertisement therein. The system further includes at least one display device operably coupled to the processing module. The at least one display device is configured to receive the at least one processed advertisement from the processor and display a representation of the at least one advertisement thereon. The system further includes an output interface operably coupled to the processing module. The output interface is configured to retrieve the at least one processed advertisement stored in the memory and output a representation of the at least one advertisement based on the at least one retrieved processed advertisement.

According to another embodiment of the present disclosure, an electronic advertisement system for displaying and exchanging advertisements includes an input interface operably coupled to a processing module. The input interface is configured to selectively receive at least one advertisement and to communicate data corresponding to the at least one advertisement to the processing module. The processing module is configured to process the data corresponding to the at least one advertisement communicated from the input interface and store the data corresponding to the at least one advertisement therein. The system further includes at least one display device operably coupled to the processing module. The at least one display device is configured to receive the processed data corresponding to the at least one advertisement from the processing module and display a representation of the at least one advertisement based on the processed data corresponding to the at least one advertisement received from the processing module. The system further includes an output interface operably coupled to the processing module. The output interface is configured to selectively retrieve the processed data corresponding to the at least one advertisement stored in the processing module and output a representation of the at least one advertisement based on the processed data corresponding to the at least one advertisement retrieved from the processing module.

The present disclosure also provides for a method for exchanging an advertisement over an electronic advertising system. The method includes the initial step of selecting at least one input parameter related to the input of at least one advertisement via an input interface. The method also includes the step of inputting the at least one advertisement into the system via the input interface based on the at least one input parameter, wherein the input interface is configured to communicate the at least one advertisement to a processing module. The method also includes the step of processing the at least one advertisement via the processing module. The processing module is configured to communicate the at least one processed advertisement to at least one display device and store the at least one processed advertisement for subsequent retrieval. The method also includes the step of representing the at least one advertisement via the least one display device based on the at least one processed advertisement received from the processing module. The method also includes the step of selecting at least one advertisement represented on the display device. The method also includes the step of selecting at least one output parameter related to the output of the at least one advertisement via an output interface, wherein the output interface retrieves the at least one selected advertisement from the processing module. The method also includes the step of generating a representation of the at least one selected advertisement via the output interface based on the at least one selected output parameter.

### BRIEF DESCRIPTION OF THE DRAWINGS

These and other advantages will become more apparent from the following detailed description of the various embodiments of the present disclosure with reference to the drawings wherein:

FIG. 1 is a block diagram of a publicly generated electronic advertisement system in accordance with the present disclosure;

FIG. 2 illustrates a front view of the system of FIG. 1 implemented according to an embodiment of the present disclosure;

FIG. 3 is a block diagram of a publicly generated electronic advertisement system in accordance with one embodiment the present disclosure; and

FIG. 4 is a flow chart diagram illustrating a method for using the publicly generated electronic advertisement systems of FIGS. 1 and 3.

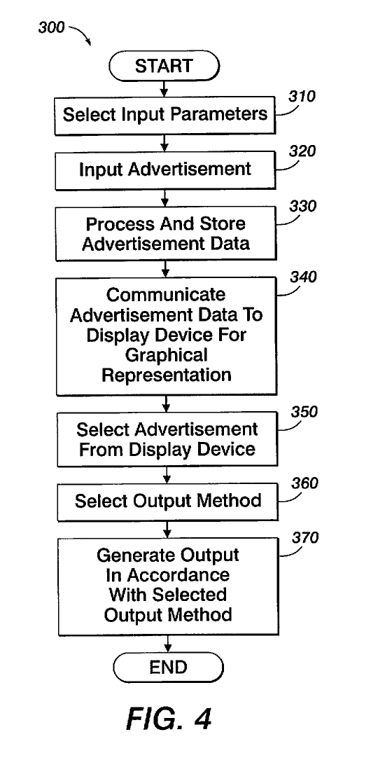

### DETAILED DESCRIPTION

Embodiments of the presently disclosed advertisement system will now be described in detail with reference to the drawings in which like reference numerals designate identical or corresponding elements in each of the several views.

Throughout this description, the term “advertisement” is defined as any information and/or data that may be input into, displayed on, and output from the system of the present disclosure; the term “advertiser” is defined as a party utilizing the system of the present disclosure to input an advertisement into the system for display thereon; and the term “consumer” is defined as a party utilizing the system of the present disclosure to output a selected advertisement displayed on the system.

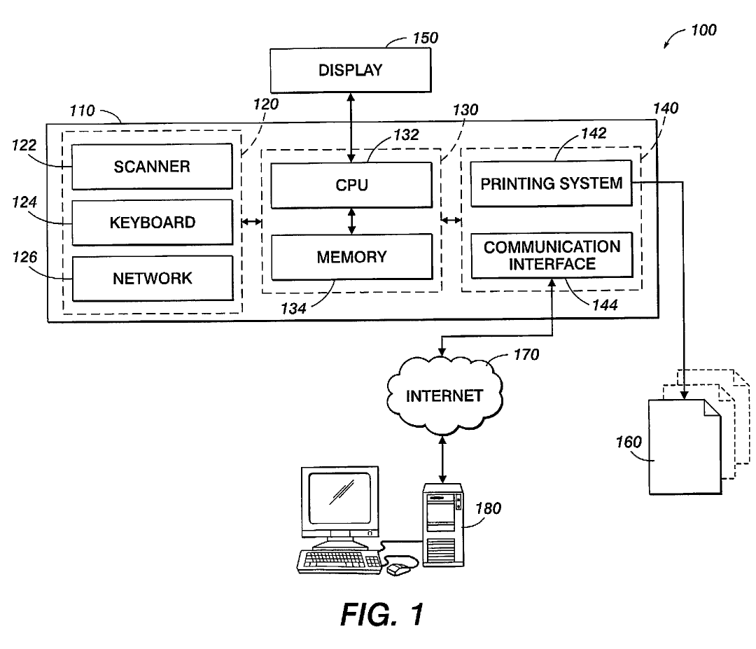

Reference is first made to FIG. 1, which shows a functional block diagram of a publicly generated electronic advertisement system 100 to facilitate the exchange of advertisements between an advertiser and a consumer in accordance with embodiments of the present disclosure.

Generally, system 100 includes an I/O component 110 in operative communication with a display device 150. In FIG. 1, I/O component 100 is shown separate from the display device 150. This configuration is illustrative only in that the I/O component may be integrally formed with the display device 150 or otherwise operably coupled thereto (e.g., in a kiosk-type configuration) or, alternatively, may be arranged such that the I/O component 110 communicates with the display device 150 via hardwiring or wirelessly over a proximity based communication linkup (e.g., Bluetooth). The I/O component 100 includes an input interface 120, a processing module 130, and an output interface 140. In use, the input interface 120 is configured to receive an advertisement (not explicitly shown) from an advertiser through a variety of methods (discussed below). The input interface 120 communicates the advertisement to the processing module 130. In embodiments, the advertisement may be converted into a digital image file (e.g., JPG, GIF, PNG, TIF, etc.) by the input interface 120 depending on the method used to input the advertisement, as will be discussed in further detail below.

The processing module 130 is configured to process and store the advertisement received from the input interface 120. Once processed and stored, the processing module communicates the processed advertisement to the display device 150. Based on the processed advertisement received from the processing module 130, the display device 150 graphically represents the advertisement. Advertisements input and processed by the system 100 for graphical representation through the display device 150, may include, but are not limited to, business cards, commercial advertisements, classified advertisements, fliers, event announcements, public announcements, help-wanted advertisements, etc. It should be appreciated that advertising may be manually entered through the input interface (e.g., via a keyboard or a touch-screen). In the case of commercial advertising, a fee may be charged to increase revenue for the owner and/or administrator of the system 100.

Operation of the I/O component 110 is controlled by the processing module 130. The processing module 130 includes a processing unit or CPU 132 and a memory 134. The memory 134 is generic and may comprise RAM, ROM, CD-ROM, or other storage such as hard disk, magnetic tape, and the like. Other devices for accepting, capturing and storing data are well known and the above list should not be construed as exhaustive.

The memory 134 may contain stored advertisement data, system software, layout templates, and/or a system handling process. The system software (not explicitly shown) is run by the CPU 132 and may reside in ROM, RAM, or other units of storage. The system software may be pre-loaded with suitable software having content filtering functionality, as is known in the art, to prevent obscene or adult-oriented materials from being graphically represented on the display device 150. In embodiments, advertisements may be stored in the memory 134 prior to being displayed on the display device 150 until viewed and approved by a system administrator. For example, the memory 134 may store advertisements in a queue based on the date of input. In this way, a system administrator may view advertisements on a first-come-first-serve basis and approve or reject advertisements accordingly. It will also be appreciated that the memory 134 may be a shared or distributed resource among many processors (not explicitly shown) in a networked configuration.

The CPU 132 is configured to process advertisements communicated from the input interface 120. Once processed, the CPU 132 stores the processed advertisement in the memory 134 and, subsequently, communicates the processed advertisement to the display device 150 for graphical representation. The system 100 may attach a so-called “time stamp” to each processed advertisement that corresponds to the date the advertisement was received by the system 100. Once the advertisement is communicated to the display device 150, the placement, representation, and/or orientation of the advertisement as graphically represented on the display device may depend on system monitored parameters such as preferences of the advertiser specified at the time of input, the category of information input (e.g., advertisement, public announcement, etc.), the category of advertisement, the amount of consideration paid by the advertiser, the attached time stamp of an advertisement, etc. For example, particular advertisements may be scheduled to be displayed at specific times based on any one or more of the above listed parameters. Further, advertisements may be displayed on the display device along with the corresponding time stamp. In embodiments, the system 100 may organize advertisements based on time stamps such that recent advertisements are displayed prior to and/or more prominently than older advertisements or vice-versa.

For purposes of illustration, input interface 120 is shown to include a scanning device 122 incorporating image capture technology, a keyboard 124, and a network 126. The input interface 120 may include any one of the above listed options or any combination thereof. It should be appreciated that input interface 120 encompasses any suitable user input device as would be within the purview of one skilled in the art. The input interface 120 may include a USB port (not explicitly shown) to which a device having so-called “plug-n-play” functionality (e.g., a flash drive, a digital picture frame, etc.) may be connected to transfer data to the I/O component 110. In this manner, users may transfer advertisements from plug-n-play devices to the system 100 for processing and subsequent display on the display device 150. Advertisements may also be output to plug-n-play devices, as will be discussed below.

In embodiments, the input interface 120 may include a card reader (not explicitly shown) in operative communication with the processing module 130 and configured to capture data from an encoded identification card (e.g., a magnetic swipe card, a smart card, a bar code, a proximity card, etc.). In this scenario, advertisers and/or consumers may utilize any suitable identification card (e.g., biometric ID cards, employee ID cards, student ID cards, government ID cards, etc.) to enter information into the system 100. A suitable identification card may include encoded information, such as a unique access-control pass number, biometric information related to the cardholder, personal contact information, electronic cash or credit for usage fees, loyalty and/or frequent usage information, etc., which the system 100 utilizes to facilitate so-called “smart system” functionality. More specifically, the data captured by the card reader is communicated to the processing module 150 for processing. The processed data may be stored in one or more databases in memory 134 to catalogue key information related to advertisers and/or consumers. Once the system 100 has captured the key information from the identification card of a particular advertiser and/or consumer, the system 100 may thereafter recognize that advertiser and/or consumer during a subsequent use based on a comparison between data stored on the system 100 and data captured from the identification card during the subsequent use. In this way, the system 100 may learn information about particular advertisers and/or consumers to facilitate a customizable experience with respect to use of the system 100. For example, once the system 100 has recognized a particular advertiser and/or consumer during a subsequent use, the system 100 may initially display advertisements from a particular category on the display device 150 based on the historical uses of the system 100 by that particular advertiser and/or consumer. For advertisers recognized by the system 100, advertisements previously posted by that particular advertiser may be retrieved and presented on the display device 150 to the advertiser. The system 100 may then query the advertiser as to whether or not the system 100 should continue to display a particular advertisement and, if so, for how long should the system 100 continue to display the advertisement.

In certain embodiments, the input interface may include a suitable payment device (e.g., a magnetic card reader) to allow advertisers to make a payment via debit card and/or credit card prior to inputting an advertisement. In this scenario, the system owner or administrator may charge the advertiser a fee for use of the system. For example, the advertiser may be made to pay more or less depending on the length of time the advertiser desires to advertise (e.g., the expiration date), the size of the advertisement and/or the surface area occupied by the advertisement, or other parameters dictated by the system owner or administrator.

The scanning device 122 may utilize image capture technology to scan advertisements for processing by the CPU 132. The scanning device 122 may be, for example, a scanner, a xerographic copy device, or integral with a print network configuration (e.g., the scanner component of a xerographic digital copier). It will be appreciated that the scanning device 122 may convert the scanned advertisement into a digital image file (e.g., JPG, GIF, PNG, TIF, etc.) and that the system software is suitably adapted to interpret the digital image file for processing by the CPU 132. In use, an advertiser uses the scanning device 122 to scan an advertisement. The digital image file is communicated to the processing module 130 and processed by the CPU 132, stored on the memory 134, and subsequently communicated to the display device 150 for graphical representation. In certain embodiments, the scanning device 122 and the keyboard 124 may be utilized in conjunction such that the advertiser utilizes the keyboard 124 to input parameters required by the system 100 prior to scanning an advertisement. For example, the system 100 may require the advertiser's contact information and location, the category of advertisement (e.g., commercial, announcement, help-wanted), the sub-category within the category of advertisement (e.g., particular industry of a commercial advertisement), the expiration of the advertisement (e.g., the desired duration of time for the advertisement to be displayed), the dimensions of the advertisement (e.g., height and width), the orientation of the advertisement (e.g., portrait or landscape), particular display devices on which to post the advertisement (discussed below), etc. Further, it may be useful to store and catalogue records related to advertiser profiles and/or preferences to streamline the system process for subsequent uses by a particular advertiser and/or consumer.

The keyboard 124 may also be utilized to interface with a plurality of layout templates (not explicitly shown) that define presentation characteristics for advertisement content to be presented on the display device 150. More specifically, specific layout templates may be defined for a variety of advertisement categories (e.g., business card, commercial advertisement, announcement, etc.) and pre-loaded into the memory 134. In use, the advertiser utilizes the input interface 120 to specify the category of advertisement to be posted (e.g., via the keyboard 124). The CPU 132 retrieves the proper layout template from the memory 134 and lays out the current advertisement content on the display device 150 using the selected layout template. Once laid out on the display device 150, manipulation and/or editing of the advertisement may be achieved through use of the input interface 120.

The network 126 may be any suitable network within the purview of one skilled in the art, such as a wired network, the Internet, a LAN, a WAN, etc. An advertiser may use any known computing device (e.g., a computer, hand-held computing device, cell phone, etc.) to remotely communicate with the input interface 120 via the network 126. In this manner, an advertiser may use the network 126 to communicate with the input interface 120 (e.g., via email, FTP, DTP, client/server, etc.) to remotely input an advertisement via the input interface 120 for processing by the processing module 130. Further, the system 100 may be adapted to interact with handheld devices (not explicitly shown) over a proximity based communication linkup (e.g. Bluetooth type communication). In embodiments, an advertiser may interact with the input interface 120 via the network 126 to post advertisements utilizing the layout templates. For example, an advertiser may scan advertisements utilizing a remote scanning device (not explicitly shown) to convert the advertisements to a digital image file. Once converted, the digital image file may be communicated over the network 126 (e.g., via email) to the processing module 130. Once received by the processing module 130, the advertisement is processed in the same way as discussed above.

In embodiments, the input interface 120 may be represented as a graphical menu interface on the display device 150 (e.g., a touch-screen) to allow the advertiser to interactively select the method of input (e.g., scanning device, keyboard, network, etc.) prior to inputting the advertisement. In other embodiments, the input interface 120 may include a graphical menu interface (not explicitly shown) in operative communication therewith, such as a touch-screen. In either configuration, supplemental information such as instructions specified for a particular method of input may be provided to the advertiser via the graphical menu interface to ensure proper operation of the input interface 120. The display device 150 may be any known electronically driven dynamic display which facilitates the display of multimedia advertising content. That is, the display device 150 can be any commercially available high contrast flat panel display, high contrast plasma display, and the like. Alternatively, the display device 150 may be electric paper (“e-paper”).

Platforms utilized to present information via the display device 150 may include any suitable multimedia platform including digital text, full motion video, audio and high resolution graphics. The multimedia platform utilized may depend on a number of system monitored parameters such as the type of display device utilized (e.g., electronic billboard, LCD, e-paper, etc.) and/or by parameters input by the advertiser at the time of posting the advertisement. In embodiments, the display device 150 may be connected to the I/O component 110 through an onboard video card (not explicitly shown) suitable to facilitate the presentation of the multimedia platforms described herein for use with embodiments of the present disclosure.

In embodiments, the display device 150 may be adapted to graphically represent advertisements in a single-page arrangement or a multi-page arrangement. In either arrangement, one or more advertisements may be represented on a given page and the system may include functionality which provides searching, zooming, scrolling, etc. For example, the advertiser and/or consumer may scroll left, scroll right, scroll up, scroll down, zoom in, and/or zoom out on the screen. Additionally, the advertiser and/or consumer could invoke page forward, page backward and go to page options using buttons or other user interface elements (not explicitly shown). To facilitate efficient searching, the system 100 may employ an interactive (e.g., touch-screen) table of contents and/or table of categories graphically represented on the display device 150 and/or a table of categories to enable quick searching based on one or more search parameters (e.g., date posted, type of advertisement, category of advertisement, industry of advertisement, etc.). In embodiments wherein the system 100 is utilized in a work-place, educational, and/or multi-residence setting, a reference directory may be graphically represented on the display device 150 to allow users to locate a particular employee, student, resident, etc. Further, the reference directory may be interactive in nature (e.g., touch-screen) to allow a user to make selections from the reference directory and obtain additional information related to parties listed in the directory (e.g., contact information).

The output interface 140 is configured to output advertisements graphically represented on the display 150. In the illustrated embodiment, the output interface 140 is in bidirectional communication with the processing module 130 and includes a printing system 142 and a communication interface 144 (e.g., a network interface).

In embodiments, the output interface 140 may be represented as a graphical menu interface on the display device 150 (e.g., a touch-screen) to allow the consumer to interactively select the desired advertisement and the method by which the selected advertisement will be output (e.g., printing system, communication interface, etc.). In other embodiments, the output interface 140 may include a graphical menu interface (not explicitly shown), such as a touch-screen, in operative communication with the output interface 140. In either configuration, supplemental information such as instructions specified for a particular method of output may be provided to the consumer via the graphical menu interface to ensure proper operation of the output interface 140. Further, the display device 150 and/or the output interface 140 may include searching functionality (e.g., via the graphical menu interface) to allow a consumer to search for a particular advertisement. For example, the consumer may search advertisements by category, location (if applicable), industry, posting date, expiration date, etc.

Printing system 142 may be, for example, one or more xerographic printing devices configured to retrieve printing instructions from the system software corresponding to the advertisement selected by the consumer and, subsequently, print the selected advertisement onto a substrate 160 (e.g., printing paper, photo paper, etc.) for retrieval by the consumer. In use, if the printing method is selected by the consumer, the printing system 142 retrieves the selected advertisement from the memory 134 via the CPU 132 and prints the advertisement onto the substrate 160. In this manner, the target user may retrieve an advertisement in a so-called “hard-copy” format from the output interface 140. This benefits the consumer in that the consumer does not require a pen and paper to write down the information from the advertisement in which they are interested. In embodiments, the output interface 140 may include a USB port (not explicitly shown) to which a device having plug-n-play functionality (e.g., a flash drive, a digital picture frame, etc.) may be connected. In this manner, selected advertisements may be output to the plug-n-play device.

The communication interface 144 may be any suitable network device configured to transmit data over a network to a remote computing device 180 (e.g., a computer, hand-held computing device, cell phone, etc.). In other words, a computer, switch, router, gateway, network bridge, proxy device or other network device that is programmed or otherwise configured to operate as explained herein is considered an embodiment of this disclosure. In the illustrated embodiment, advertisements presented on the display device 150 may be transmitted from the communication interface 144 to a remote computing device 180 (e.g., a computer, hand-held computing device, cell phone, etc.) via e-mail over a network (e.g., Internet 170) or via text message over a wireless network. In use, a consumer interacts with the output interface 140 (e.g., utilizing the card reader to capture data from an identification card) to specify an email address (or multiple email addresses) to which the consumer desires the selected advertisement(s) to be transmitted. If the e-mail method of output is selected by the consumer, the communication interface 144 retrieves the selected advertisement from the memory 134 via the CPU 132 and transmits an e-mail containing the advertisement (e.g., as an attached file) to the consumer-selected email address over a network (e.g., the Internet 170) to the remote computing device 180. It should be appreciated that the communication interface 144 is configured to transmit advertisements to a single email address or multiple email addresses. Advertisements output through the communication interface 144 may be, for example, a replicated image of the advertisement (e.g., a digital image file) or text in the body of the email and/or attached as a text file containing particular information corresponding to the advertisement (e.g., contact information). In other embodiments, advertisements may be printed directly to a print image file, such as a TIFF, PostScript, RIP, PDF or PCL file and subsequently attached to the email.

In embodiments, coupons and/or information related to a selected advertisement may also be output through the communication interface 144. For example, the system 100 may automatically email coupons to a consumer based on a currently selected advertisement and/or periodically email coupons to a consumer based on advertisements previously selected by that consumer as recognized by the system 100 based on prior uses. Further, communication interface 144 and network 126 may be configured to operate via a common network device utilizing an incoming server (e.g., network 126) and an outgoing server (e.g., communication interface 144).

More specifically, a consumer may select advertisements presented on the display device 150 by interacting with the output interface 140. For example, the output interface 140 may be represented as a graphical menu interface on the display device 150 (e.g., a touch-screen) to allow the consumer to select particular advertisements, select the method of outputting the selected advertisements (e.g., printing, email, etc.), and/or enter an email address to which the selected advertisements are to be transmitted. Additionally or alternatively, the output interface 140 may include a graphical menu interface (not explicitly shown) in operative communication therewith, such as a touch-screen. In either configuration, supplemental information such as instructions specified for a particular method of output may be provided to the consumer via the graphical menu interface to ensure the advertisement is properly output from the output interface 140. Once an advertisement is selected by the consumer, the output interface 140 retrieves the selected information from the memory 134 via the CPU 132 and outputs the information according to the method specified by the consumer via the output interface 140.

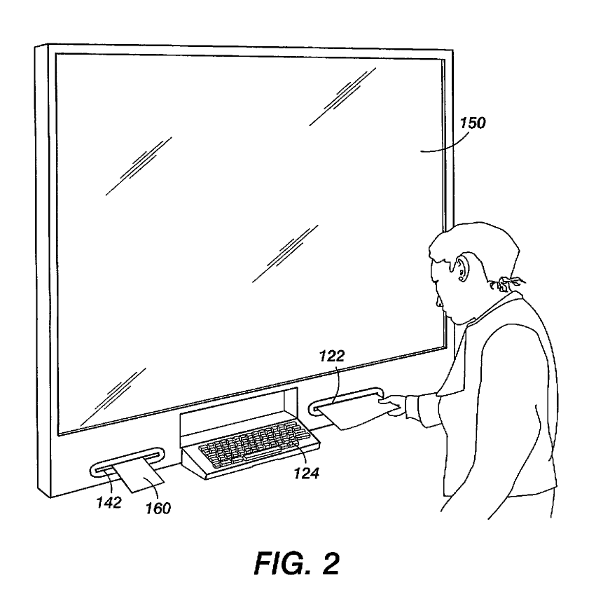

With reference to FIG. 2, an embodiment of the system 100 of FIG. 1 is shown to illustrate a user interacting with the I/O component 100. The illustrated embodiment of the system 100 depicts the display device 150 mounted to a wall surface and operably coupled to the I/O component 100. For purposes of illustration, the I/O component 100 is shown to include the scanning device 122, keyboard 124, and printing system 142. The user of the system 100 is depicted interacting with the scanning device 122 to input an advertisement to the system 100 in the manner discussed above with reference to FIG. 1. In other embodiments, the I/O component 110 may be configured to communicate with the display device 150 remotely. For example, the I/O component 110 may be separated into individual components (e.g., the scanning device 122, keyboard 124, and printing system 142) and/or may be mounted to a wall surface in the proximity of the display device or positioned on the surface of a table-like structure or wall unit in the proximity of the display device.

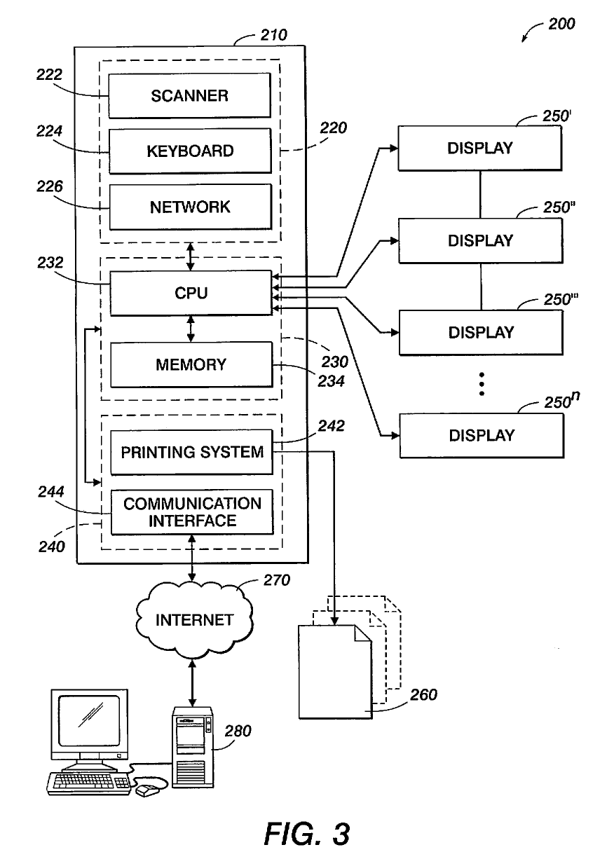

FIG. 3 shows a detailed block diagram of a publicly generated electronic advertisement system 200 according to another embodiment of the present disclosure. The system 200 operates similarly to the system 100 shown in FIG. 1 and is only described to the extent necessary to illustrate the differences with respect to the first embodiment. System 200 includes an I/O component 210 having an input interface 220, a processing module 230, and an output interface 240. The I/O component 210 is in bidirectional communication with a display device system 250 having a plurality of display devices 250′-250ⁿ.

Operation of the I/O component 210 is controlled by the processing module 230. The processing module 230 includes a processing unit or CPU 232 in bidirectional communication with a memory 234. The processing module 230 is configured to process advertisements received from the input interface 220 and subsequently communicate the advertisements to any one or more display devices 250′-250ⁿ. The memory 234 is configured to store advertisements processed by the CPU 232 for subsequent retrieval.

In use of the embodiment illustrated in FIG. 2, an advertiser may operate the input interface 220 to input an advertisement via a scanning device 222, a keyboard 224, remotely over a network 226, or any combination thereof. With the multiple display device configuration of the illustrated embodiment, the input interface 220 provides the advertiser with the option to select one or more display devices 250′-250ⁿ on which to post the advertisement (discussed below). This option is in addition to the options made available to the advertiser by the system 100 embodied in FIG. 1.

In the illustrated embodiment, the display devices 250′-250ⁿ are shown in operative communication with a single I/O component 210. This configuration is illustrative only and each of the display devices 250′-250ⁿ may include a dedicated I/O component. Each dedicated I/O component may be in operative communication with the dedicated I/O component of any one or more of the other display devices 250′-250ⁿ, e.g., in a networked configuration. In this manner, a single I/O component may be utilized to input or output an advertisement from any one or more display devices or, alternatively, an I/O component dedicated to any one display devices may be utilized to input or output an advertisement presented on any one or more display devices.

The output interface 240 is in bidirectional communication with the CPU 232 and includes a printing system 242 and a communication interface 244. The printing system 242 is configured to print consumer-selected advertisements to a substrate 260. The communication interface 244 is configured to transmit consumer selected advertisements from the communication interface 244 to a remote computing device 280 (e.g., a computer, hand-held computing device, cell phone, etc.) via e-mail over a network (e.g., Internet 170). The output interface 240 is configured to output advertisements selected by the consumer presented on any one or more of the display devices 250′-250ⁿ.

The configuration of system 200 may be advantageous, for example, in a university scenario wherein an advertiser posts an advertisement to any one or more selected display devices 250ⁿ. Users viewing the display devices 250ⁿ (e.g., students) may select content in which they are interested (e.g., via touch-screen, by swiping an identification card encoded with contact information, etc.) and a follow-up email or text message containing the content or information related thereto may be sent to the student for subsequent retrieval from a computer in their dorm room.

FIG. 3 illustrates a method for utilizing the systems of the presently disclosed embodiments of FIGS. 1 and 2. In step 310, the advertiser selects input parameters such as the category of advertisement to be input, the method of inputting the advertisement into the input interface 120, 220 (e.g., scanning device, keyboard), the advertisers contact information and location, the expiration of the advertisement, and the particular display devices on which the advertisement is to be displayed. In step 320, the advertiser inputs the advertisement into the input interface 120, 220 in accordance with the method of input selected in step 310. In step 330, the advertisement input in step 320 is communicated to the processing module 130, 230 and processed by the CPU 132, 232. Once processed, the advertisement or, data corresponding thereto, is stored into the memory 134, 234 for subsequent retrieval. In step 340, the CPU 132, 232 communicates the processed advertisement to the display device(s) 150, 250ⁿ for graphical representation of the advertisement. Advertisements graphically represented on the display device(s) 150, 250ⁿ, may be searched by a consumer

In step 350, a consumer selects an advertisement graphically represented on one or more display devices 150, 250ⁿ (via steps 310-340) for subsequent output via the output interface 140, 240. In step 360, the consumer selects the desired method of outputting the advertisement selected in step 350 via the output interface 140, 240. In step 370, the advertisement selected in step 350 is output in accordance with the method of output selected in step 360.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. An electronic advertisement system for displaying and exchanging advertisements, comprising:
an input interface operably coupled to a processing module and configured to communicate at least one advertisement thereto, the processing module including a processor configured to process the at least one advertisement communicated from the input interface and a memory operably coupled to the processor and configured to store the at least one processed advertisement therein;
at least one display device operably coupled to the processing module and configured to receive the at least one processed advertisement from the processor and display a representation of the at least one advertisement thereon; and
an output interface operably coupled to the processing module and configured to retrieve the at least one processed advertisement stored in the memory and output a representation of the at least one advertisement based on the at least one retrieved processed advertisement.

2. A system according to claim 1, wherein the representation of the at least one advertisement is a graphical image.

3. A system according to claim 1, wherein the input interface includes a scanning device in operative communication with the processing module and configured to capture an image of the at least one advertisement and communicate the captured image to the at least one display device via the processing module.

4. A system according to claim 1, wherein the input interface includes a keyboard in operative communication with the processing module and configured to communicate the at least one advertisement to the at least one display device via the processing module.

5. A system according to claim 1, wherein the input interface includes a network in operative communication with the processing module and configured to facilitate the transfer of the at least one advertisement from a remote computing device to the processing module.

6. A system according to claim 1, wherein the at least one display device is a flat-panel display.

7. A system according to claim 1, wherein the at least one display device is configured to display the representation of the at least one advertisement via electronic paper.

8. A system according to claim 1, wherein the output interface includes at least one printing device in operative communication with the processing module and configured to output the representation of the at least one advertisement onto a substrate.

9. A system according to claim 1, wherein the output interface includes a communication interface in operative communication with the processing module and configured to output the representation of the at least one advertisement over a network to a remote computing device.

10. A system according to claim 9, wherein the representation of the at least one advertisement is output over the network to the remote computing device via email.

11. A system according to claim 1, wherein the at least one display device includes a graphical user interface in operative communication with the processing module and configured to facilitate the selection of at least one parameter related to the representation of the at least one advertisement.

12. A system according to claim 1, wherein at least one of the input interface and the at least one display device includes a graphical user interface in operative communication with the processing module and configured to facilitate the selection of at least one parameter related to the input of the at least one advertisement.

13. A system according to claim 1, wherein at least one of the output interface and the at least one display device includes a graphical user interface in operative communication with the processing module and configured to facilitate the selection of at least one parameter related to the output of the at least one advertisement.

14. A system according to claim 1, wherein the system includes a plurality of display devices in a networked configuration.

15. A system according to claim 1, wherein the output interface is configured to output the representation of the at least one advertisement via a print image file.

16. An electronic advertisement system for displaying and exchanging advertisements between a plurality of users, comprising:
an input interface operably coupled to a processing module and configured to selectively receive at least one advertisement, the input interface further configured to communicate data corresponding to the at least one advertisement to the processing module, wherein the processing module is configured to process the data corresponding to the at least one advertisement communicated from the input interface, and wherein the processing module is further configured to store the data corresponding to the at least one advertisement therein;
at least one display device operably coupled to the processing module and configured to receive the processed data corresponding to the at least one advertisement therefrom, wherein the at least one display device is further configured to display a representation of the at least one advertisement based on the processed data corresponding to the at least one advertisement received from the processing module; and
an output interface operably coupled to the processing module and configured to selectively retrieve the processed data corresponding to the at least one advertisement stored in the processing module, wherein the output interface is further configured to output a representation of the at least one advertisement based on the processed data corresponding to the at least one advertisement retrieved from the processing module.

17. A system according to claim 16, wherein the input interface is further configured to capture user data from an encoded card and communicate the user data to the processing module for processing and storage therein.

18. A system according to claim 17, wherein the display device is further configured to display the representation of the at least one advertisement based on the user data stored in the processing module.

19. A system according to claim 16, wherein the processing module comprises a CPU operably coupled to a memory configured to store the data corresponding to the at least one advertisement, wherein the CPU is configured to communicate the data corresponding to the at least one advertisement to at least one of the output interface and the at least one display device.

20. A method for exchanging an advertisement over an electronic advertising system, comprising:
selecting at least one input parameter related to the input of at least one advertisement via an input interface;
inputting the at least one advertisement into the system via the input interface based on the at least one input parameter, wherein the input interface is configured to communicate the at least one advertisement to a processing module;
processing the at least one advertisement via the processing module, the processing module configured to communicate the at least one processed advertisement to at least one display device and store the at least one processed advertisement for subsequent retrieval;
representing the at least one advertisement via the at least one display device based on the at least one processed advertisement received from the processing module;
selecting at least one advertisement represented on the display device;
selecting at least one output parameter related to the output of the at least one selected advertisement via an output interface, wherein the output interface retrieves the at least one selected advertisement from the processing module; and
generating a representation of the at least one selected advertisement via the output interface based on the at least one selected output parameter.

21. A method according to claim 20, wherein the inputting step further comprises the step of:
scanning the at least one advertisement into the system via a scanning device in operative communication with the processing module.

22. A method according to claim 20, wherein the inputting step further comprises the step of:
utilizing a keyboard to input information related to the at least one advertisement in accordance with at least one layout template graphically represented on at least one of the input interface and the at least one display device.

23. A method according to claim 20, wherein the inputting step further comprises the step of:
utilizing a remote computing device to input the at least one advertisement over a network in operative communication with the processing module.

24. A method according to claim 20, wherein the generating step further comprises the step of:
printing the representation of the at least one selected advertisement onto a substrate via a printing device.

25. A method according to claim 20, wherein the generating step further comprises the step of:
transmitting the representation of the at least one advertisement to a remote computing device via a communication interface in operative communication with the processing module.

26. A method according to claim 20, wherein the inputting step further includes the steps of capturing user data from an encoded card and communicating the user data to the processing module for processing and storage therein.

27. A method according to claim 26, further including the step of representing at least one advertisement via the at least one display device based on the user data stored in the processing module.
